(19) United States
(12) Patent Application Publication
(10) Pub. No.: US 2022/0178341 A1
(43) Pub. Date: Jun. 9, 2022

(54) OCEAN ENERGY COLLECTION DEVICE

(71) Applicant: Shanghai University, Shanghai (CN)

(72) Inventors: Yan Peng, Shanghai (CN); Fan Shen, Shanghai (CN); Zhongjie Li, Shanghai (CN); Jun Luo, Shanghai (CN); Shaorong Xie, Shanghai (CN); Huayan Pu, Shanghai (CN)

(73) Assignee: Shanghai University, Shanghai (CN)

(21) Appl. No.: 17/541,598

(22) Filed: Dec. 3, 2021

(30) Foreign Application Priority Data
Dec. 7, 2020 (CN) 202011440553.0

(51) Int. Cl. F03B 13/16

(52) U.S. Cl. CPC F03B 13/16; B63B 2022/006; F05B 2260/42; F05B 2220/706

(57) ABSTRACT

An ocean energy collection device is provided. The device includes a first friction assembly, a second friction assembly, and a gravity center adjustment assembly disposed in sequence from outside to inside, and a control and energy storage assembly arranged on the gravity center adjustment assembly. The first friction assembly includes a spherical housing, a first electrode layer, and a first friction layer which are disposed in sequence from outside to inside. The second friction assembly includes a tumbler-shaped shell, a second electrode layer, and a second friction layer which are disposed in sequence from inside to outside. The gravity center adjustment assembly is fixed in the tumbler-shaped shell. The first friction assembly and the second friction assembly can realize electrification by friction. The first electrode layer, the second electrode layer, and the gravity center adjustment assembly are connected with the control and energy storage assembly.

### CROSS REFERENCE TO RELATED APPLICATION

This patent application claims the benefit and priority of Chinese Patent Application No. 202011440553.0 filed on Dec. 7, 2020, the disclosure of which is incorporated by reference herein in its entirety as part of the present application.

### TECHNICAL FIELD

The present disclosure relates to the field of ocean energy power generation technologies, in particular, to an ocean energy collection device.

### BACKGROUND ART

With the increasing demand for energy, the use of clean and renewable energy has become a research hotspot today. It is irreversible for the thermal power generation in terms of the energy consumption and the harm to the environment, and the ocean contains a large amount of renewable energy. The tidal energy, wave energy and other ocean energy are used to generate power, which is of great significance to the realization of sustainable development.

As a major maritime country, China has continuously deepened the exploration of the ocean. The power supplying of various types of ocean sensors often relies on solar power or chemical batteries. However, the weather at sea is often unpredictable. The solar energy cannot provide continuous and stable power. Moreover, chemical batteries involve replacement problems, cumbersome operations, and high cost. The wave energy is used for power generation, so that the power can be supplied to various types of sensors continuously and stably, which is extremely important for ocean scientific researches and national defense construction.

### SUMMARY

To solve the above technical problems, the present disclosure provides an ocean energy collection device which has a simple structure and can continuously and stably supply power to various types of sensors while realizing self-power, and avoids the cumbersome step of replacing batteries.

To achieve the above-mentioned purpose, the present disclosure provides the following solution.

The present disclosure provides an ocean energy collection device, including a first friction assembly, a second friction assembly, a gravity center adjustment assembly, and a control and energy storage assembly. The first friction assembly, the second friction assembly, and the gravity center adjustment assembly are disposed in sequence from outside to inside. The control and energy storage assembly is arranged on the gravity center adjustment assembly. The first friction assembly includes a spherical housing, a first electrode layer, and a first friction layer which are disposed in sequence from outside to inside. The second friction assembly includes a tumbler-shaped shell, a second electrode layer, and a second friction layer which are disposed in sequence from inside to outside. The gravity center adjustment assembly is fixed in the tumbler-shaped shell. The first friction assembly and the second friction assembly are capable of electrification by friction; and the first electrode layer, the second electrode layer, and the gravity center adjustment assembly are connected with the control and energy storage assembly.

In some embodiments, the first electrode layer may be arranged on an inner wall of the spherical housing, and the second electrode layer may be arranged on an outer wall of a lower part of the tumbler-shaped shell.

In some embodiments, the first friction layer may include multiple first friction belts which are transversely and vertically disposed in a staggered manner at equal intervals, and the second friction layer may include multiple second friction belts which are transversely and vertically disposed in a staggered manner at equal intervals.

In some embodiments, a width of each of the first friction belts may be the same as a distance between adjacent two of the first friction belts. A width of each of the second friction belts may be the same as a distance between adjacent two of the second friction belts; and the width of the second friction belt may be the same as the width of the first friction belt.

In some embodiments, the gravity center adjustment assembly may include an upper storage container, a guide pipe, and a lower storage container which are connected with each other in sequence from top to bottom. The guide pipe may extend to a bottom of the lower storage container; the lower storage container may be configured to contain volatile liquid. An electric heating wire may cover an upper part of the lower storage container. The electric heating wire may be connected with the control and energy storage assembly. The control and energy storage assembly may be arranged on the lower storage container; and the lower storage container may be fixed in the tumbler-shaped shell.

In some embodiments, an outer wall of a lower end of the lower storage container may be fitted to the tumbler-shaped shell.

In some embodiments, the control and energy storage assembly may include a rectifier bridge, an energy storage component, a single-chip microcomputer, and a gyroscope. The first electrode layer, the second electrode layer, the energy storage component, and the single-chip microcomputer may be connected with the rectifier bridge. The energy storage component may be connected with the electric heating wire; and the electric heating wire and the gyroscope may be both connected with the single-chip microcomputer.

In some embodiments, the energy storage component may be a lithium cell, and the volatile liquid is ethyl ether.

Compared with the prior art, the following beneficial technical effects are achieved in the present embodiments.

The ocean energy collection device provided by the present disclosure includes the first friction assembly, the second friction assembly, the gravity center adjustment assembly, and the control and energy storage assembly. The first friction assembly includes the spherical housing, the first electrode layer, and the first friction layer which are disposed in sequence from outside to inside. And, the second friction assembly includes the tumbler-shaped shell, the second electrode layer, and the second friction layer which are disposed in sequence from inside to outside. The spherical housing can rotate in any direction under the impact of seawater and can collect waves in any direction to generate power. The tumbler-shaped shell inside can keep continuous reciprocating movement, and a resultant relative displacement makes the first friction assembly and the second friction assembly generate power. By using the principle of electrification by friction, low-frequency energy can be well collected. And, as for the uncertainty of the waves, the tumbler-shaped shell and the gravity center adjustment assembly are adopted, which can well improve the efficiency and the stability of power generation and provide a stable power output. The device has a simple structure, is flexible and simple, can continuously and stably supply power to various types of ocean intelligent sensors while fully realizing self-power, and avoids the cumbersome step of replacing batteries. Furthermore, the device uses the ocean energy, which is more environmentally friendly.

### BRIEF DESCRIPTION OF THE DRAWINGS

In order to describe embodiments of the present disclosure or technical solutions in the prior art more clearly, drawings required to be used in the embodiments will be briefly introduced below. It is apparent that the drawings in the descriptions below are only some embodiments of the present disclosure. Those of ordinary skill in the art also can obtain other drawings according to these drawings without making creative work.

FIG. 1 is a schematic structural diagram of an ocean energy collection device according to the present disclosure;

FIG. 2 is a schematic structural diagram of a first friction assembly in the ocean energy collection device according to the present disclosure;

FIG. 3 is a schematic structural diagram of a second friction assembly in the ocean energy collection device according to the present disclosure;

FIG. 4 is a schematic diagram showing a power generation principle of the ocean energy collection device according to the present disclosure;

FIG. 5 is a schematic structural diagram of a gravity center adjustment assembly in the ocean energy collection device according to the present disclosure;

FIG. 6 is a schematic diagram of a working state of the gravity center adjustment assembly in the ocean energy collection device according to the present disclosure; and

FIG. 7 is a schematic diagram of a circuit connection of a control and energy storage assembly in the ocean energy collection device according to the present disclosure.

List of the reference characters: 100 ocean energy collection device; 1 first friction assembly; 101 spherical housing; 102 first electrode layer; 103 first friction layer; 1031 first friction belt; 2 second friction assembly; 201 tumbler-shaped shell; 202 second electrode layer; 203 second friction layer; 2031 second friction belt; 3 gravity center adjustment assembly; 301 upper storage container; 302 guide pipe; 303: lower storage container; 304 low-boiling-point liquid; 305 electric heating wire; 4 control and energy storage assembly; 401 rectifier bridge; 402 energy storage component; 403 single-chip microcomputer; and 404 gyroscope.

### DETAILED DESCRIPTION OF THE EMBODIMENTS

The following clearly and completely describes the technical solution in the embodiments of the present disclosure in combination with the accompanying drawings of the embodiments of the present disclosure. Apparently, the described embodiments are only part of the embodiments of the present disclosure, not all embodiments. Based on the embodiments in the present disclosure, all other embodiments obtained by those of ordinary skill in the art without creative work shall fall within the protection scope of the present disclosure.

The present embodiment aims to provide an ocean energy collection device which has a simple structure and can continuously and stably supply power to various types of sensors while realizing self-power, and avoids the cumbersome step of replacing batteries.

In order to make the above-mentioned purposes, characteristics and advantages of the present invention more apparent and understandable, the present invention is further described in detail below with reference to the accompanying drawings and specific implementation modes.

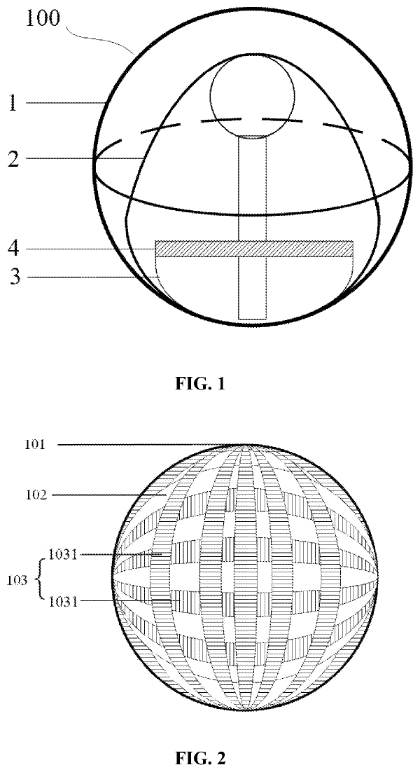

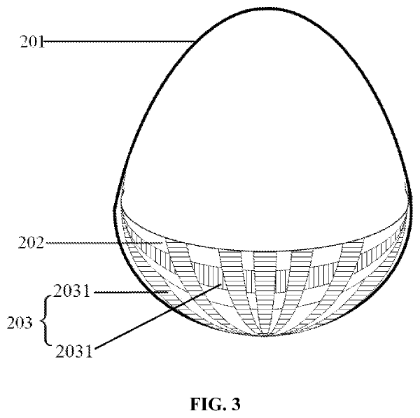

As shown in FIG. 1 to FIG. 3, the present embodiment provides an ocean energy collection device 100, which includes a first friction assembly 1, a second friction assembly 2, a gravity center adjustment assembly 3, and a control and energy storage assembly 4. The first friction assembly 1, the second friction assembly 2, and the gravity center adjustment assembly 3 are disposed in sequence from outside to inside. The control and energy storage assembly 4 is arranged on the gravity center adjustment assembly 3. The control and energy storage assembly 4 can serve as a mass block. The first friction assembly 1 includes a spherical housing 101, a first electrode layer 102, and a first friction layer 103 which are disposed in sequence from outside to inside. The second friction assembly 2 includes a tumbler-shaped shell 201, a second electrode layer 202, and a second friction layer 203 which are disposed in sequence from inside to outside. The gravity center adjustment assembly 3 is fixed in the tumbler-shaped shell 201. The first friction assembly 1 and the second friction assembly 2 can realize electrification by friction; and the first electrode layer 102, the second electrode layer 202, and the gravity center adjustment assembly 3 are all connected with the control and energy storage assembly 4.

The spherical housing 101 can rotate in any direction under the impact of seawater and can collect waves in any direction to generate power. The tumbler-shaped shell 201 inside can keep continuous reciprocating movement, and a resultant relative displacement makes the first friction assembly 1 and the second friction assembly 2 generate power. By using the principle of electrification by friction, low-frequency energy can be well collected. The tumbler-shaped shell 201 is reversely used. Due to the characteristic of the tumbler-shaped shell 201 which continuously swings during keeping it in a state of not being fallen down, the utilization efficiency of the waves is further improved. As for the uncertainty of the waves, the tumbler-shaped shell 201 and the gravity center adjustment assembly 3 are adopted, which can well improve the efficiency and the stability of power generation and provide a stable power output. The device has a simple structure, is flexible and simple, can continuously and stably supply power to various types of ocean intelligent sensors while fully realizing self-power, and avoid the cumbersome step of replacing batteries. Furthermore, the ocean energy is used, which is more environmentally friendly.

The first electrode layer 102 is arranged on an inner wall of the spherical housing 101. Specifically, the first electrode layer 102 is overspread on the inner wall of the spherical housing 101. The second electrode layer 202 is arranged on an outer wall of a lower part of the tumbler-shaped shell 201. Specifically, the second electrode layer 202 is overspread at one-third of a total height of the tumbler-shaped shell 201. The lower part of the tumble shell 201 refers to a part where the gravity center of the tumbler-shaped shell 201 is located.

To generate relatively high power generation efficiency by means of the cooperation between the first friction assembly 1 and the second friction assembly 2, the first electrode layer 102 and the second electrode layer 202 may use any metal with good electric conductivity, such as silver, copper, and aluminum. The first friction layer 103 may use a non-metal material with relatively high gain-electronics capacity in triboelectric series, such as polyethylene, polypropylene, and polytetrafluoroethylene. The second friction layer 203 may use any non-metal material with relatively high loss-electronics capacity in triboelectric series, such as ethyl cellulose ether, nylon, and wool.

In this specific embodiment, the spherical housing 101 uses an acrylic material. The first electrode layer 102 uses a copper electrode; and the first friction layer 103 uses polytetrafluoroethylene. The tumbler-shaped shell 201 uses the acrylic material; the second electrode layer 202 uses the copper electrode; and the second friction layer 203 uses nylon.

The first friction layer 103 includes a plurality of first friction belts 1031 which are transversely and vertically disposed in a staggered manner at equal intervals, and the second friction layer 203 includes a plurality of second friction belts 2031 which are transversely and vertically disposed in a staggered manner at equal intervals. The first friction layer 103 and the second friction layer 203 are alternately arranged, so that energy of waves in different degrees can be better collected, and the efficiency of power generation is improved.

A width of each first friction belt 1031 is the same as a distance between two adjacent the first friction belts 1031. A width of each second friction belt 2031 is the same as a distance between two adjacent the second friction belts 2031. And the width of the second friction belt 2031 is the same as the width of the first friction belt 1031.

Specifically, in this embodiment, one-sixteenth of a perimeter of a cross section of the spherical housing 101 is used as the width of each first friction belt 1031 in the first friction layer 103. It should be noted that the width and the number of the first friction belts 1031 can be adjusted according to an actual situation.

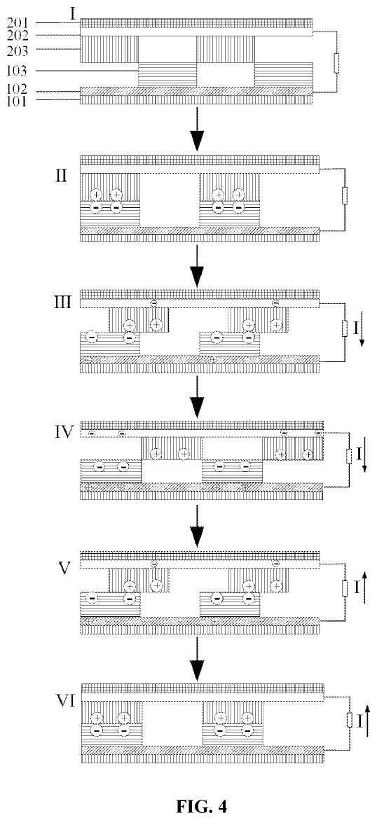

As shown in FIG. 4, at the beginning, the first friction layer 103 and the second friction layer 203 are not contacted. When the waves impact, the spherical housing 101 will rotate, and the gravity center of the tumbler-shaped shell 201 will keep down all the time and only swing left and right within a small range. The first friction assembly 1 and the second friction assembly 2 will maintain a continuous contact-separation movement. When the first friction layer 103 and the second friction layer 203 are in complete contact with each other, the number of negative charges on a surface of the first friction layer 103 reaches a maximum, and the number of positive charges on a surface of the second friction layer 203 reaches a maximum. The spherical housing 101 continues to rotate, and the first friction layer 103 and the second friction layer 203 are separated. To balance the potential difference, the first electrode layer 102 and the second electrode layer 202 generate induced current. When the first friction layer 103 and the second friction layer 203 are completely separated, the induced current reaches the highest. The spherical housing 101 continues to rotate, and the first friction layer 103 and the second friction layer 203 are contacted with each other again. The potential difference decreases, and an external circuit generates a reverse current. Under the impact of the waves, the above process is continuously circulated, and the ocean energy collection device 100 in the present embodiment can continuously generate power.

As shown in FIG. 5, the gravity center adjustment assembly 3 includes an upper storage container 301, a guide pipe 302, and a lower storage container 303 which are connected with each other in sequence from top to bottom. The lower storage container 303 contains low-boiling-point liquid 304 (i.e., volatile liquid). An upper part of the lower storage container 303 is covered with an electric heating wire 305 which is connected with the control and energy storage assembly 4. The control and energy storage assembly 4 is arranged on the lower storage container 303; and the lower storage container 303 is fixed in the tumbler-shaped shell 201. The guide pipe 302 extends to the bottom of the lower storage container 303, and a liquid level of the low-boiling-point liquid 304 is higher than a bottom end surface of the guide pipe 302 to realize liquid sealing. The volatile low-boiling-point liquid 304 can generate a relatively large pressure intensity difference between the upper storage container 301 and the lower storage container 303 at a small temperature difference, after being heated by the electric heating wire 305. The low-boiling-point liquid is then pressed to the upper storage container 301 to change the gravity center of the gravity center adjustment assembly, thus achieving the purpose of controlling the tumbler-shaped shell 201 to swing.

Specifically, the volume of the low-boiling-point liquid 304 is a half volume of the lower storage container 303, and the height of a lower part of the electric heating wire 305 is greater than the height of the low-boiling-point liquid 304 by 1-3 mm. The low-boiling-point liquid 304 in the present embodiment is ethyl ether.

In this specific embodiment, the lower storage container 303 uses a structure that has a square top and a round bottom; and the outer wall of the lower end of the lower storage container 303 is fitted to the tumbler-shaped shell 201. The upper storage container 301 is a spherical shell.

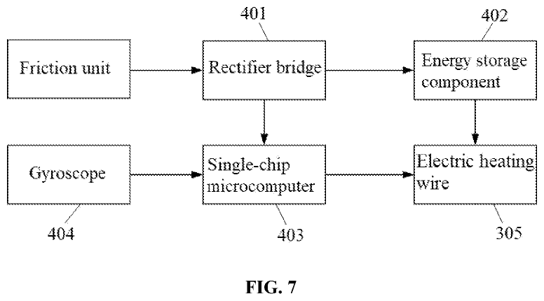

As shown in FIG. 7, the control and energy storage assembly 4 includes a rectifier bridge 401, an energy storage component 402, a single-chip microcomputer 403, and a gyroscope 404. The first electrode layer 102, the second electrode layer 202, the energy storage component 402, and the single-chip microcomputer 403 are all connected with the rectifier bridge 401. The energy storage component 402 is connected with the electric heating wire 305; and the electric heating wire 305 and the gyroscope 404 are both connected with the single-chip microcomputer 403. The energy storage component 402 stores redundant energy generated in case of large waves and supplies power to the gravity center adjustment assembly 3 in case of small waves. The swing amplitude of the tumbler-shaped shell 201 is controlled by changing the gravity center of the tumbler-shaped shell, and the efficiency of power generation is improved, so as to keep the stability of external power supply. In this specific embodiment, the energy storage component 402 is a lithium cell.

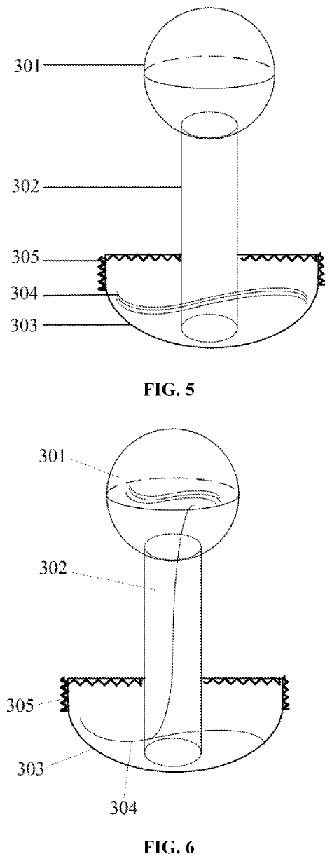

Specifically, a friction unit including the first friction assembly 1 and the second friction assembly 2 is connected with the energy storage component 402 through the rectifier bridge 401. When the waves are large, the efficiency of power generation is high, and the redundant energy can be stored. Meanwhile, the rectified electric energy is used to supply power to the single-chip microcomputer 403 and the gyroscope 404. When the gyroscope 404 of the control and energy storage assembly 4 detects that the swing amplitude of the tumbler-shaped shell 201 is less than 22.5 degrees (360/16 degrees, i.e., the tumbler-shaped shell cannot completely cross one friction belt by one swing thereof) under small waves, the single-chip microcomputer 403 controls the gravity center adjustment assembly 3 to start to work, and the electric energy stored in the energy storage component 402 is supplied to the electric heating wire 305. The ethyl ether can be volatilized with the help of a little energy since its boiling point is only 34.5 Celsius degrees. As shown in FIG. 6, the electric heating wire 305 heats the ethyl ether to quickly evaporate the ethyl ether, and the pressure intensity in the lower storage container 303 rapidly increases. The ethyl ether is extruded to the upper storage container 301 via the guide pipe 302. At this time, the gravity center is changed, so that the swing amplitude of the tumbler-shaped shell 201 increases and thus the efficiency of the friction unit is improved. When the gyroscope 404 detects that the swing amplitude of the tumbler-shaped shell 201 is greater than 33.75 degrees (22.5×1.5 degrees), heating is stopped. That is, the electric energy stored in the energy storage component 402 is saved while the power generation efficiency is guaranteed. Automatic adjustment of the efficiency of power generation is realized by means of the gravity center adjustment assembly 3.

The principle and implementation modes of the present disclosure are described by applying specific examples in the present specification. The descriptions of the above embodiments are only intended to help to understand the method of the present disclosure and a core idea of the method. In addition, those ordinarily skilled in the art can make changes to the specific implementation modes and the application scope according to the idea of the present disclosure. From the above, the contents of the present specification shall not be deemed as limitations to the present disclosure.

1. An ocean energy collection device, the device comprising a first friction assembly, a second friction assembly, a gravity center adjustment assembly, and a control and energy storage assembly, wherein the first friction assembly, the second friction assembly, and the gravity center adjustment assembly are disposed in sequence from outside to inside; the control and energy storage assembly is arranged on the gravity center adjustment assembly; the first friction assembly comprises a spherical housing, a first electrode layer, and a first friction layer which are disposed in sequence from outside to inside; the second friction assembly comprises a tumbler-shaped shell, a second electrode layer, and a second friction layer which are disposed in sequence from inside to outside; the gravity center adjustment assembly is fixed in the tumbler-shaped shell; the first friction assembly and the second friction assembly are capable of electrification by friction; the first electrode layer, the second electrode layer, and the gravity center adjustment assembly are connected with the control and energy storage assembly; the gravity center adjustment assembly comprises an upper storage container, a guide pipe, and a lower storage container which are connected with each other in sequence from top to bottom; the guide pipe extends to a bottom of the lower storage container; the lower storage container is configured to contain volatile liquid; an electric heating wire covers an upper part of the lower storage container; the electric heating wire is connected with the control and energy storage assembly; the control and energy storage assembly is arranged on the lower storage container; and the lower storage container is fixed in the tumbler-shaped shell; the control and energy storage assembly comprises a rectifier bridge, an energy storage component, a single-chip microcomputer, and a gyroscope; the first electrode layer, the second electrode layer, the energy storage component, and the single-chip microcomputer are connected with the rectifier bridge; the energy storage component is connected with the electric heating wire; and the electric heating wire and the gyroscope are both connected with the single-chip microcomputer.

2. The ocean energy collection device according to claim 1, wherein the first electrode layer is arranged on an inner wall of the spherical housing, and the second electrode layer is arranged on an outer wall of a lower part of the tumbler-shaped shell.

3. The ocean energy collection device according to claim 2, wherein the first friction layer comprises a plurality of first friction belts which are transversely and vertically disposed in a staggered manner at equal intervals, and the second friction layer comprises a plurality of second friction belts which are transversely and vertically disposed in a staggered manner at equal intervals.

4. The ocean energy collection device according to claim 3, wherein a width of each of the first friction belts is the same as a distance between adjacent two of the first friction belts; a width of each of the second friction belts is the same as a distance between adjacent two of the second friction belts; and the width of the second friction belt is the same as the width of the first friction belt.

5. (canceled)

6. The ocean energy collection device according to claim 1, wherein an outer wall of a lower end of the lower storage container is fitted to the tumbler-shaped shell.

7. (canceled)

8. The ocean energy collection device according to claim 1, wherein the energy storage component is a lithium cell, and the volatile liquid is ethyl ether.
